(19) United States
(12) Patent Application Publication
(10) Pub. No.: US 2002/0167605 A1
(43) Pub. Date: Nov. 14, 2002

(54) Photographing apparatus

(76) Inventors: Kazuo Akimoto, Narashino-shi (JP); Motoharu Sakurai, Narashino-shi (JP); Junichi Nio, Narashino-shi (JP)

Correspondence Address: ADAMS & WILKS, ATTORNEYS AND COUNSELORS AT LAW, 31ST FLOOR, 50 BROADWAY, NEW YORK, NY, 10004, US

(21) Appl. No.: 10/140,720

(22) Filed: May 8, 2002

(30) Foreign Application Priority Data
May 9, 2001 (JP) 2001-138423
Apr. 8, 2002 (JP) 2002-105548

(51) Int. Cl. H04N 5/225

(52) U.S. Cl. 348/374; 348/340

(57) ABSTRACT

A photographing apparatus has a driving circuit and a photographing element driven by the driving circuit mounted to a circuit board, and an optical apparatus unit mounted to the circuit board at a position with respect to the photographing element to enable an image to be photographed by the photographing element. The optical apparatus unit comprises a holder for holding an optical member at an inner portion thereof, the holder having a male screw portion at an outer periphery thereof, and a main plate having a holder receiver provided with a female screw portion corresponding to the male screw portion of the holder. The main plate is mounted to the circuit board. The holder is molded of plastic and the male screw portion of the holder is provided with a first male screw portion having a first diameter and a second male screw portion having a second diameter smaller than the first diameter. A separating line of die members used in molding the holder of the plastic is disposed at the second male screw portion, having the smaller diameter, so that a burr formed at the separating line does not extend outward of the holder beyond the first male screw thread portion. A screw thread of the second male screw portion is set to overlap by a predetermined amount a screw thread of the female screw portion when the male screw portion of the holder is screwed into the female screw portion of the holder receiver.

### FIELD OF THE INVENTION

The present invention relates to a photographing apparatus (also called a solid state photographing apparatus or camera) mounted to a portable telephone, a notebook type personal computer, or the like.

### DESCRIPTION OF THE RELATED ART

A known solid state photographing apparatus has a holder comprising a lens unit formed of molded plastic and is constructed such that a male screw portion of one of the holder and a holder receiver for receiving the holder, and a female screw portion of the other, are screwed together for assembly. Focusing is performed by adjusting the distance between a lens and a photographing element by controlling the amount by which the holder and the holder receiver are screwed together.

In the known photographing apparatus having the plastic holder, when die cavities are separated after molding the holder, the plastic is swollen in the shape of a line along a matching line (separating line) between the die cavities to thereby produce a so-called burr. The burr produced by separating die members during plastic molding projects from the screw thread. As a result, when the male screw portion and the female screw portion are screwed together, the burr formed in the plastic mold is ground into a powder and falls into inner portions of the photographing apparatus or adheres to the photographing element to hamper formation of a high-quality photographed image.

Various approaches have been taken in order to prevent the burr of the plastic mold from being ground into powder and falling into the inner portion of the photographing apparatus. One such approach is shown in FIGS. 5A and 5b. The burr D produced when separating the die cavities is formed at a recessed location. To do this, a male screw portion B of the holder A is formed with at least one parallel notched face C at opposed positions. The burr D is formed on the notched face C. It is necessary that the notching of each parallel notched face C is done to a sufficient depth to avoid grinding the burr to produce powder when screwing together the holder and holder receiver. Thus, the depth of notching of the parallel face C is required to be sufficiently deep.

By forming the parallel notched faces C sufficiently recessed from the screw thread of the holder A in the foregoing manner, a burr D produced at the dividing line when the die members are separated is not brought into contact with the female screw portion when screwing together the holder and the receiver. Therefore, the burr is not ground and the powder of the plastic is not produced. However, since it is necessary to form the parallel notched faces C sufficiently recessed from the screw thread, the male screw portion and the female screw portion are not screwed together at the notched portions C and leakage of light is caused thereat. In an apparatus requiring a high degree of light shielding performance, such as a camera, it is extremely undesirable to allow leakage of light into the notched parallel faces C.

An object of the present invention is to provide a molded plastic part having a screw thread that is received into a corresponding screw thread of another part without grinding a burr produced when separating molding die members.

Another object of the present invention is to provide a molded plastic part having a screw thread that is received into a corresponding screw thread of another part without substantial light leakage through the screw threads.

Still another object of the present invention is to provide a photographing apparatus having a holder and a holder receiver, in which a plastic burr formed during molding is prevented from being ground into powder and falling into the apparatus or adhering to a photographing element, and in which leakage of light is prevented to enable producing a neat photographed image.

### SUMMARY OF THE INVENTION

In order to achieve the foregoing objects and others, a solid state photographing apparatus according to one aspect of the present invention comprises a circuit board, a camera driving circuit mounted to the circuit board, a photographing element driven by the driving circuit mounted to the circuit board, and an optical apparatus unit mounted to the circuit board at a position with respect to the photographing element at which an image can be photographed by the photographing element. The optical apparatus unit comprises a holder for holding an optical member at an inner portion thereof and having a male screw portion at an outer periphery thereof, and a main plate having a holder receiver provided with a female screw portion screwed to the male screw portion and connected to the camera circuit board.

The holder is molded of plastic, and the male screw portion is provided with a first male screw portion having a first diameter and a second male screw portion having a second diameter smaller than the first diameter. A separating line formed by die members used for molding the holder of the plastic is disposed at the second male screw portion having the smaller diameter and a screw thread of the second male screw portion having the smaller diameter is set to overlap by a predetermined amount a screw thread of the female screw portion when the holder is screwed into the holder receiver.

By the foregoing construction, only the first male screw portion of the holder, having the larger diameter, is screwed to a screw thread of the female screw portion of the holder receiver. The second male screw portion of the holder, having the smaller diameter, is not screwed to the female screw portion of the holder receiver. Therefore, a burr formed in a die separating line is not ground into a powder as in the known apparats. Furthermore, since a predetermined overlapping amount is provided between the screw thread of the second male screw portion and the screw thread of the female screw portion, leakage of light is not caused from the portion.

### BRIEF DESCRIPTION OF THE DRAWINGS

FIG. 1 is a plan view showing an embodiment of the present invention;

FIG. 2 is a sectional view taken along a line A-A of FIG. 1;

FIG. 3A is a partially notched front view of a holder of the embodiment and FIG. 3B is a bottom view thereof;

FIG. 4 is a sectional view enlarging a portion of FIG. 2; and

FIG. 5A is a partially notched front view of a holder of a conventional example and FIG. 5B is a bottom view thereof.

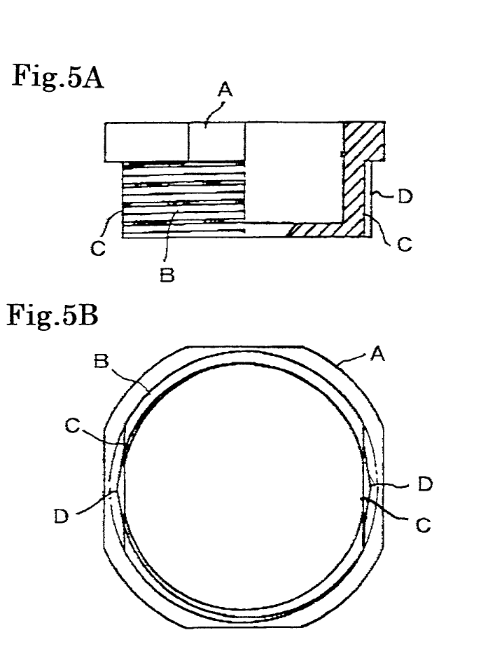

### DETAILED DESCRIPTION OF THE PREFERRED EMBODIMENTS

With reference to the attached drawings, a description will be given herein of a preferred embodiment of the present invention in the form of a photographing apparatus incorporated in a portable device such as a portable telephone or the like.

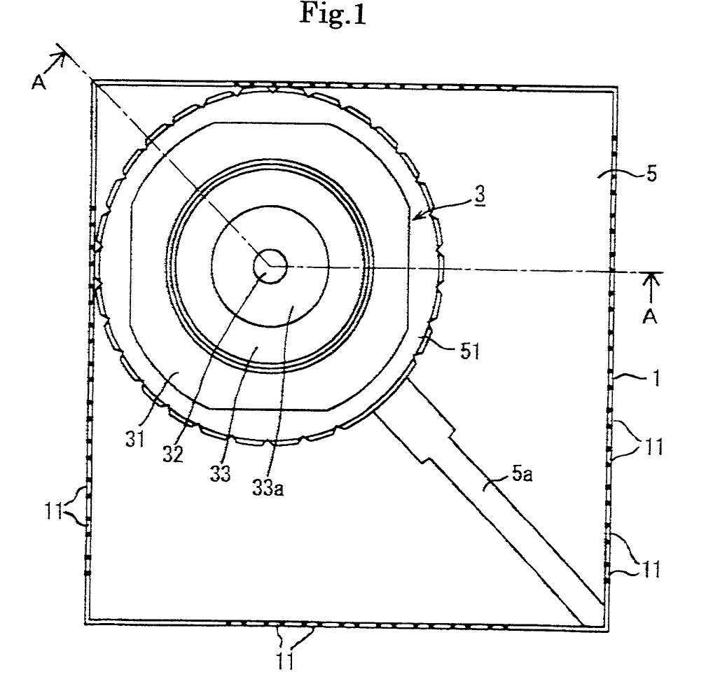

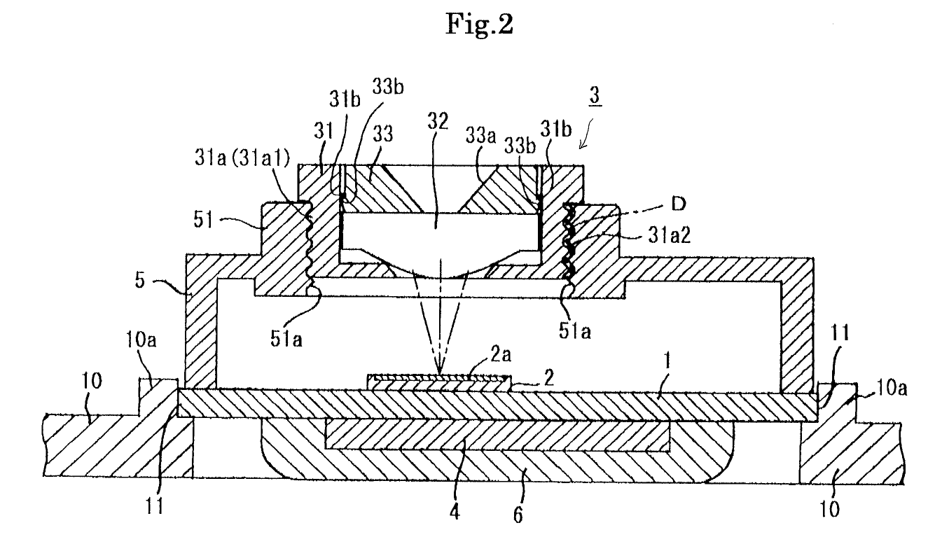

As illustrated in FIGS. 1 and 2, a socket portion 10a of a main body circuit board 10 of a portable apparatus is fitted with a camera circuit board 1, and a connection terminal portion 11 formed at an end face thereof is opposed to a connection terminal portion formed at an inner face of the socket portion 10a and is connected to a predetermined terminal portion of the main body circuit board 10.

The connection terminal portion 11 of the camera circuit board 1 is produced as follows. Wiring patterns are formed on a front face and a back face of a board. A through-hole is formed at a center of the wiring patterns. Copper paste or the like, constituting a conductive member, is embedded in the through-hole and the board is cut through the center of the through-hole so that the end face thereof is a flat face. The connection terminal portion 11 then has gold-plated layers formed on surfaces of the wiring patterns of the front face and the back face and the copper paste. In this manner, the connection terminal portion 11 does not constitute a recessed portion at the end face of the camera circuit board 1 but is aligned at the end face. Therefore, by fitting the end face to the socket portion 10a, the connection terminal portions 11 are opposed to connection terminal portions opposedly formed at the inner face of the socket portion 10a and are connected to the predetermined terminal portion of the main body circuit board 1.

A photographing element 2 is provided on a front face side of the camera circuit board 1 and a terminal portion, not illustrated, of the photographing element 2 and the connection terminal portion 11 of the camera circuit board 1 are bonded by wire bonding to be electrically connected to each other. A light receiving portion 2a is provided at a center of the front face of the photographing element 2 and is opposed to a lens, as described below.

The camera circuit board 1 is adhered to a back side of a box-shaped main plate 5. An optical apparatus unit 3 is attached to a front side of the main plate 5. The optical apparatus unit 3 holds an optical member such as a lens 32 or the like. The lens 32 is held by a holder 31, and a lens holder 33 is inserted into an open end of the holder 31 and fixed therein to hold the lens 32 in place by engaging a projection 31b provided on an inner peripheral side of the holder 31 with a projection 33b provided on an outer peripheral side of the lens holder 33 to undetachably hold the lens 32. The lens holder 33 is provided with a diaphragm portion 33a. The holder 31 is molded of plastic.

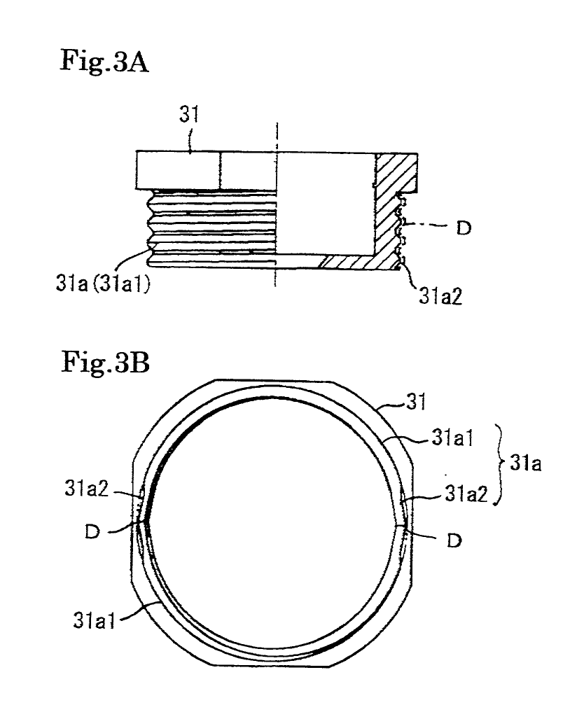

As illustrated in greater detail by FIGS. 3A and 3B, a main screw portion 31a comprising a male screw thread is provided at an outer periphery of the holder 31. The main screw portion 31a has a first male screw portion 31a1 having a first predetermined diameter and a second male screw portion 31a2 having a second predetermined diameter smaller than the first predetermined diameter at positions opposed to each other in the illustrated example. A separating line of die members, that is, a matching line of die members used in the injection molding of the holder 31, is disposed at the male screw portion 31a2 having the smaller diameter. Therefore, when the die cavities are separated during plastic molding of the holder 31, a burr D is formed in the shape of a line along the separating line. However, since the second male screw portion 31a2 has a smaller diameter than the first male screw portion 31a1, the burr D does not project beyond the first predetermined diameter of the first male screw portion 31a1.

Referring back to FIG. 2, the main plate 5 is provided with a holder receiver 51 for accommodating the holder 31. The holder receiver 51 is formed with a female screw portion 51a adapted to be screwed to the male screw portion 31a. As described above, the male screw portion 31a is formed with the male screw portion 31a2 having the smaller diameter, and the die separating line formed during plastic molding of the holder 31 is disposed at the smaller diameter portion 31a2. Therefore, the burr D is produced at the male screw portion 31a 2 having the smaller diameter and does not project out beyond the first predetermined diameter of the male screw portion 31a1. When the male screw portion 31a and the female screw portion 51a are screwed together, the burr D is not ground into powder and does not fall into an inner portion of the main plate 5 or drop onto the photographing element 2.

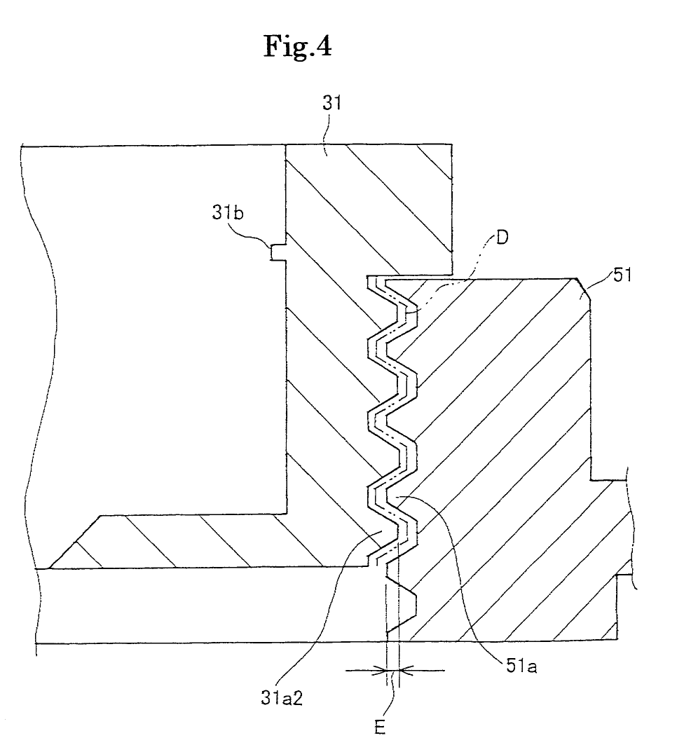

Further, as shown in the enlarged view of FIG. 4, the screw thread of the second male screw portion 31a2 having the smaller diameter is set to provide a predetermined overlapping amount E between itself and a screw thread of the female screw portion 51a. Since the screw thread of the second male screw portion 31a 2 having the smaller diameter is set to provide the overlapping amount E, even when the male screw portion 31a and the female screw portion 51a are screwed together and the second male screw portion 31a 2 having the smaller diameter and the female screw portion 51a are not screwed together but are separated from each other, the screw threads of the two screw portions are overlapped by the overlapping amount E. Therefore, light is prevented from invading in an optical axis direction by the screw threads alternately projecting from opposed sides and leakage of light is not caused at the overlap portion. In contrast thereto, the male screw portion of the above-described known photographing apparatus is formed with a parallel notched face sufficiently recessed from the screw thread to allow light to invade in the optical axis direction due to the clearance provided between the parallel notched face and the female screw portion and there is a problem that high light shielding performance is not achieved. According to the present invention, however, by providing the predetermined overlapping amount E as described above, the problem of leakage of light can also be resolved.

A distance between the lens 32 and the photographing element 2 can be adjusted by rotatably adjusting the holder 31 with respect to the holder receiver 51 to cause rotation between the female screw portion 51a of the holder receiver 51 and the male screw portion 31a of the holder 31 so that focusing can be carried out.

An element extending diagonally in FIG. 1 is a rib 5a which reinforces the front face of the main plate 5 such that the front face is not bent even when a plate thickness thereof is thin.

As shown by FIG. 2, an IC 4 for driving the photographing element 2 is provided at the back face of the camera circuit board 1. The IC 4 is bonded to a predetermined wiring pattern provided at the back face of the camera circuit board 1 by wire bonding. At a region surrounding the IC 4, circuit elements, not illustrated, are aligned and connected at positions spaced apart from each other at predetermined intervals. Potting resin 6 is made to flow to inner portions of the aligned circuit elements. Since the alignment of the circuit elements function as a wall, further spread of the potting resin 6 is prevented and the potting resin 6 is cured to protect the IC 4.

In the foregoing manner, the optical apparatus unit 3 is attached to the front side of the main plate 5 and the camera circuit board 1 is attached to the back side to thereby form a camera unit. When the camera unit constructed in the foregoing manner is connected to the main body circuit board 10 as described above, assembly is finished.

Although according to the example explained above, the socket portion 10a is provided at the main body circuit board 10 and the camera circuit board 1 is fitted and connected thereto, the invention is not limited thereto and the end face of the connection terminal portion 11 may be connected to the predetermined terminal of the circuit board 10 of a portable apparatus by using solder or the like. Further, although the above-described embodiment is provided in a portable apparatus, the invention is not limited thereto but the camera apparatus may be provided in a monitoring apparatus or the like.

In this way, according to the present invention, the male screw portion of the holder is provided with a larger diameter male screw portion and a smaller diameter male screw portion having a diameter smaller than that of the larger diameter male screw portion, and the die separating line is disposed at the smaller diameter male screw portion. Therefore, even when a burr is produced along the die separating line due to molding of the holder, when screwing together the male screw portion and the female screw portion of the holder receiver, the burr is not ground into powder. The screw thread of the smaller diameter male screw portion is set to provide the predetermined overlapping amount between the screw thread of the male screw portion and the screw thread of the female screw portion. Therefore, although the male screw portion having the small diameter is not screwed to the female screw portion, leakage of light from the portion is not caused from the portion and therefore, a neat photographed image can be formed.

What is claimed is:

1. A photographing apparatus comprising:
a circuit board;
a driving circuit mounted to the circuit board;
a photographing element mounted to the circuit board and being driven by the driving circuit; and
an optical apparatus unit mounted to the circuit board at a position with respect to the photographing element to enable an image to be photographed by the photographing element;
wherein the optical apparatus unit comprises a holder for holding an optical member at an inner portion thereof, the holder having a male screw portion at an outer periphery thereof, and a main plate having a holder receiver provided with a female screw portion for receiving the male screw portion of the holder, the main plate being mounted to the circuit board;
wherein the holder is molded of plastic, the male screw portion of the holder is provided with a first male screw portion having a first diameter and a second male screw portion having a second diameter smaller than the first diameter, and a separating line of die members used in molding the holder of the plastic is disposed at the second male screw portion, so that a burr formed at the separating line does not extend outward of the holder beyond the first male screw thread portion; and
wherein a screw thread of the second male screw portion is set to overlap a screw thread of the female screw portion by a predetermined amount when the male screw portion of the holder is screwed into the female screw portion of the holder receiver.

2. A photographing apparatus according to claim 1; wherein the optical member comprises a lens.

3. A photographing apparatus according to claim 2; further comprising a lens holder fixedly attached to the holder for holding the lens within the holder; wherein the holder has a projection provided on an inner peripheral side thereof to engage a projection formed on an outer peripheral side of the lens holder to fixedly hold the lens, and the lens holder has a diaphragm to allow light to pass therethrough.

4. A photographing apparatus according to claim 1; wherein the circuit board is mounted to a circuit board of a portable electronic device.

5. A photographing apparatus comprising:
a circuit board;
a driving circuit mounted to the circuit board;
a photographing element mounted to the circuit board and being driven by the driving circuit; and
an optical apparatus unit mounted to the circuit board at a position with respect to the photographing element to enable an image to be photographed by the photographing element;
wherein the optical apparatus unit comprises a holder for holding an optical member at an inner portion thereof and having a screw thread, and a main plate having a holder receiver provided with a screw thread corresponding to the screw thread of the holder, the main plate being mounted to the circuit board;
wherein the screw thread of one of the holder and the holder receiver is provided with a first portion having a first diameter and a second portion having a second diameter different from the first diameter, and a separating line of die members used in molding the one of the holder and the holder receiver of plastic is disposed at the second portion so that a burr formed at the separating line does not extend into a screw thread path between the screw thread of the holder and the screw thread of the holder receiver.

6. A photographing apparatus according to claim 5; wherein the screw thread having the first and second portions comprises a male screw thread formed on an outer peripheral surface of the holder, and the screw thread of the holder receiver is a female screw thread.

7. A photographing apparatus according to claim 6; wherein the first diameter is larger than the second diameter.

8. A photographing apparatus according to claim 5; wherein the second portion of the screw thread is set to overlap the screw thread of the holder receiver by a predetermined amount when the screw threads of the holder and the holder receiver are screwed together.

9. A molded plastic part having a male screw thread portion for being received within a corresponding female screw thread of another part, the male screw thread portion comprising: a first male screw thread portion having a first diameter; and a second male screw thread portion having a second diameter smaller than the first diameter; and a burr formed at a separating line of die members used in molding the plastic part, the separating line being disposed at the second male screw thread portion so that the burr does not come into contact with the female screw thread of the other part when the molded plastic part is screwed into the other part.

10. A molded plastic part according to claim 9; wherein the second male screw thread portion is set to overlap by a predetermined amount the female screw thread of the other part when the molded plastic part is screwed into the female screw thread of the other part.

11. A molded plastic part according to claim 10; further comprising a portion for holding a lens; and wherein the other part comprises a holder receiver for receiving the molded plastic part, the holder receiver being formed in an optical apparatus unit.
